(19) United States
(12) Patent Application Publication
(10) Pub. No.: US 2008/0276463 A1
(43) Pub. Date: Nov. 13, 2008

(54) Folding knife

(76) Inventor: Chih-Chen Kao, Taoyuan City (TW)

Correspondence Address: BACON & THOMAS, PLLC, 625 SLATERS LANE, FOURTH FLOOR, ALEXANDRIA, VA, 22314-1176, US

(21) Appl. No.: 11/798,080

(22) Filed: May 10, 2007

(51) Int. Cl. B26B 1/02

(52) U.S. Cl. 30/155

(57) ABSTRACT

The present invention discloses a folding knife, which comprises a blade pivotally coupled to an end of a knife handle for pivoting out of the knife handle or being received into the knife handle, a resilient bar with an end fixed to another end of the knife handle and another end extended to the blade proximate to the pivotal connecting position, and a push switch installed proximate to the pivotal connecting position with an end extended to a surface of the knife handle and another end passed through the knife handle and against the blade, such that when the push switch is pushed to drive the blade to turn to a predetermined angle, the resilient bar produces a torque to turn the blade out from the knife handle automatically, so that a user simply needs to push the push switch for the control of turning the blade out from the knife handle.

### FIELD OF THE INVENTION

The present invention relates to a folding knife, and more particularly to a folding knife that allows a user to turn the blade out from the knife handle through pushing a push switch outside the knife handle by a hand, so that when the push switch pushes the blade to turn to a predetermined angle, a resilient bar installed inside the knife handle produces a torque to turn the blade out from the knife handle, such that the blade pivots out of the knife handle automatically.

### BACKGROUND OF THE INVENTION

In recent years, a folding knife available in the market generally comes with a knife handle and a blade, wherein in an end of the blade is pivotally coupled to an end of the knife handle, such that the blade can pivot with respect to a pivotal connecting position of the blade and the knife handle, and be turned out from the knife handle or stored into the knife handle. If a user wants to turn the blade out from the knife handle of the folding knife, the user needs to hold the knife handle by one hand, and pull the blade from the other hand in order to pull the blade out from the knife handle. However, a major drawback of such folding knife resides in that users have to turn the blade out by both hands, and thus users cannot use such folding knife by one hand to cope with emergencies or a special situations. For example, if a diver gets tangled by a fish net while diving, the diver will not be able to cut the fish net by the folding knife immediately, and thus will put the diver's life in danger.

To overcome the aforementioned shortcoming, a conventional switchblade having a hollow handle 20 and a blade 21 as shown in FIG. 1 was introduced. The hollow handle 20 can be used for receiving the blade 21, and the blade 21 includes a knife-edge portion 211 disposed on a side of the blade 21 and a pivotal connecting portion 212 disposed at an end of the blade 21, and the pivotal connecting portion 212 is pivotally coupled to a shaft 22 at an end of the hollow handle 20. The hollow handle 20 includes a resilient member 23 therein for connecting the blade 21, and a press switch 24 protruded from a surface of the hollow handle 20 for latching the blade 21 and disposed on another side of the blade 21 in the hollow handle 20 and proximate to the shaft 22, such that when a user presses the press switch 24, the press switch 24 releases the blade 21 and allows the blade 21 to be pivoted out from the hollow handle 20 quickly by the resilience of the resilient member 23. In other words, the user can simply operate the switchblade 2 quickly and easily by a hand.

However, the press switch 24 is protruded from a prominent position on the surface of the hollow handle 20, and thus the press switch 24 may be touched or triggered accidentally by a user or a child, and the blade 21 will pivot out of the hollow handle 20, and thus may cut or injure the user, and such design with good intentions may be turned out to be a risk to users. If the switchblade 2 is put into a user's pocket, a slight external touch or strike may trigger the press switch 24 to turn the blade 21 out of the hollow handle 20 or may cut or prick the user's body. Although conventional switchblades are convenient to use, they also create a big threat to users and fail to meet the strict safety requirements.

Therefore, knife manufactures focus on the safe design of a knife, in addition to the stylish look, function and convenience of the knife. Therefore, the design of knives not only shows personal tastes, but also integrates the features of user-friendliness, multiple functions and convenience while maintaining a simple structural design and improving safety. High safety is one of the key factors to success or gain market shares for a knife manufacturer. Finding a way of enhancing the product safety to meet strict safety requirements while maintaining the convenience of use becomes an important subject for knife manufacturers.

### SUMMARY OF THE INVENTION

In view of the foregoing shortcomings of the prior art, the inventor of the present invention based on years of experience in the related industry to conduct extensive researches and experiments, and finally developed a folding knife in accordance with the present invention to overcome the shortcomings of the prior art.

It is a primary objective of the present invention to provide a folding knife, comprising a knife handle, and a blade pivotally coupled to an end of the knife handle and allowing the blade to pivot out of the knife handle or to be received into the knife handle with respect to a pivotal connecting position of the blade and knife handle. The knife handle includes a resilient bar and a push switch, wherein an end of the resilient bar is fixed into a position proximate to another end of the knife handle, and another end of the resilient bar is extended to the pivotal connecting position of the knife handle and the blade. If the blade is received completely into the knife handle, the resilient bar will produce a torque to turn the blade towards the knife handle, such that the blade is received stably and completely into the knife handle. The push switch is installed proximate to the pivotal connecting position of the knife handle and the blade, and an end of the push switch is extended to a surface of the knife handle, and another end of the push switch is passed through the knife handle and connected with the blade. If the push switch is pushed to drive the blade to turn to a predetermined angle until the resilient bar produces a torque to turn the blade out from the knife handle, the blade will pivot out of the knife handle automatically, so that a user simply needs to push the push switch for the control of turning the blade out from the knife handle. The present invention can overcome the safety issue of conventional switchblades.

To make it easier for our examiner to understand the objective, technical characteristics and effects of the present invention, preferred embodiments will be described with accompanying drawings as follows:

### BRIEF DESCRIPTION OF THE DRAWINGS

FIG. 1 is an exploded view of a conventional switchblade;

FIG. 2 is a schematic view of a folding knife in accordance with a first preferred embodiment of the present invention;

FIG. 3 is a schematic view of a folding knife in accordance with a second preferred embodiment of the present invention;

FIG. 4 is a schematic view of a folding knife in accordance with a third preferred embodiment of the present invention; and

FIG. 5 is an exploded view of a folding knife in accordance with the present invention.

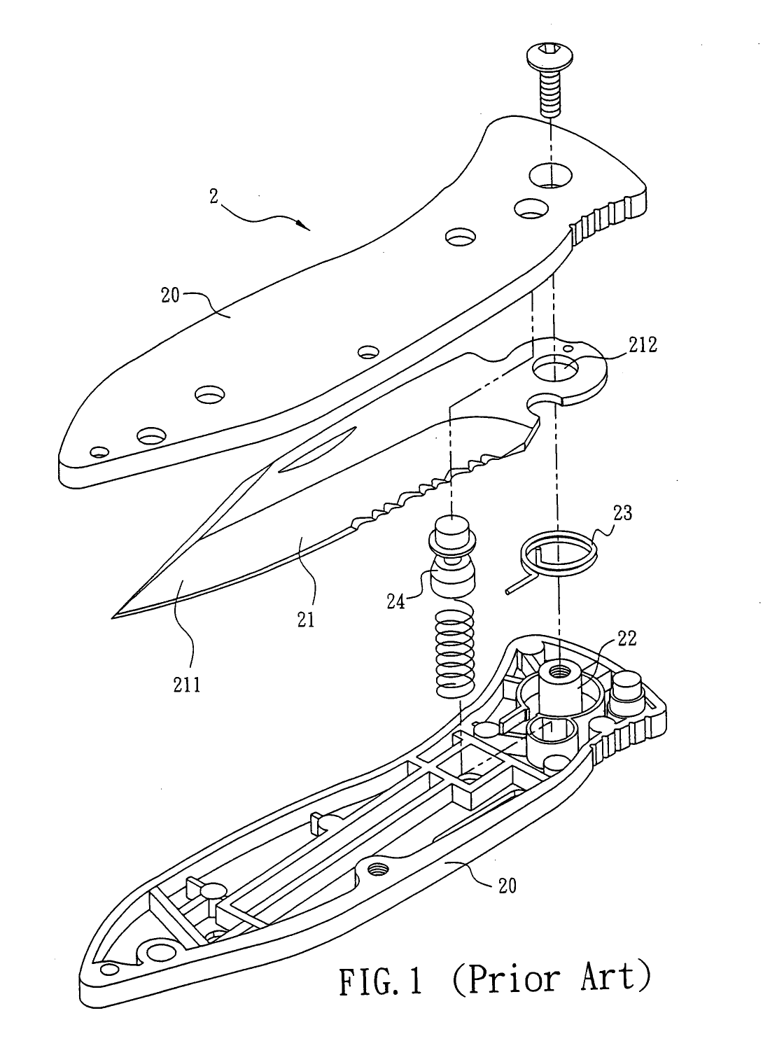

### DETAILED DESCRIPTION OF THE PREFERRED EMBODIMENTS

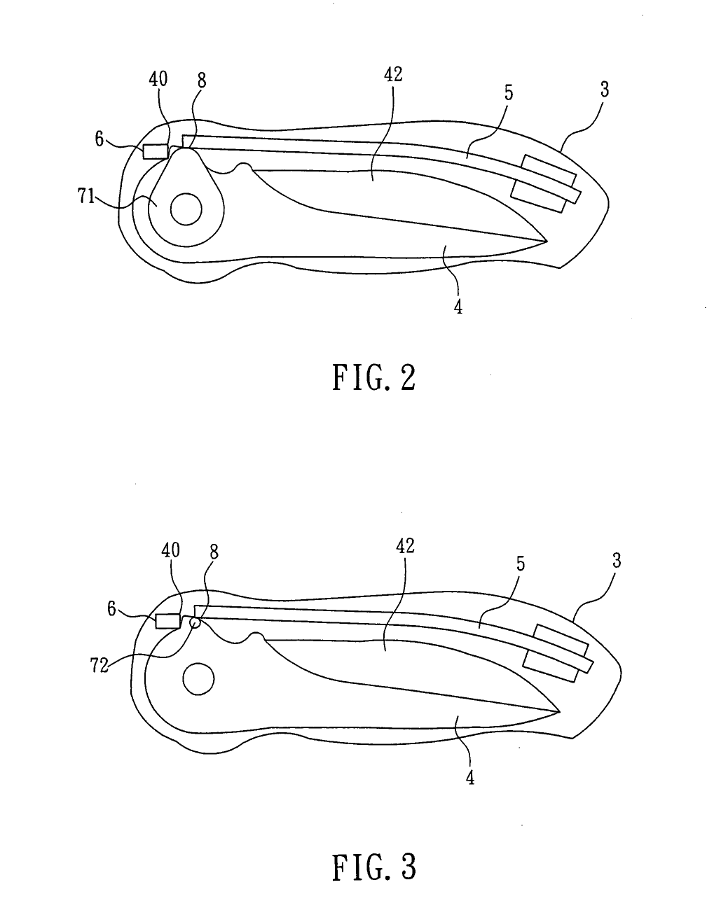

Referring to FIGS. 2 to 4 for a folding knife of the present invention, the folding knife comprises a knife handle 3, a blade 4, a resilient bar 5 and a push switch 6, wherein an end of the blade 4 is pivotally coupled to an end of the knife handle 3, such that the blade 4 can pivot out of the knife handle 3 or received completely into the knife handle 3 with respect to a pivotal connecting position of the knife handle 3 and blade 4 for being used to cut objects, or reducing the storage space of the folding knife, facilitating users to carry the folding knife, and preventing the blade 4 from causing injuries to people or damages to objects. An end of the resilient bar 5 is fixed into another end proximate to the knife handle 3, and another end of the resilient bar 5 is extended to the knife handle 3 at a position proximate to the pivotal connecting position of the knife handle 3 and the blade 4, and the push switch 6 is disposed on the knife handle 3 and proximate to the pivotal connecting position of the knife handle 3 and the blade 4, and an end of the push switch 6 is extended to a surface of the knife handle 3, and another end of the push switch 6 is passed through the knife handle 3 and against the blade 4.

With the foregoing structure, if the blade 4 is received completely into the knife handle 3, the resilient bar 5 can produce a torque for turning the blade 4 towards the knife handle 3, so that the blade 4 can be received stably and completely in the knife handle 3. Even if the folding knife is shaken, the blade 4 will not pivot out of the knife handle 3 easily. If the push switch 6 is pushed by a user, the push switch 6 will drive the blade 4 to turn to a predetermined angle, and the resilient bar 5 will produce a torque for turning the blade 4 out from the knife handle 3, such that the blade 4 can pivot out of the knife handle 3 automatically. Such arrangement can prevent the push switch 6 from being touched or triggered accidentally, and the blade 4 from pivoted out form the knife handle 3 unexpectedly, so as to enhance the safety of the conventional switchblades. In addition, a user simply needs to push the push switch 6 by a hand to turn the blade 4 out from the knife handle 3 automatically, and the invention can improves the convenience and safety of the folding knife.

In a first preferred embodiment of the present invention as shown in FIG. 2, the blade 4 includes a cam 71 disposed on a pivotal connecting position of the blade 4 and the knife handle 3, and the periphery of the cam 71 is pressed by another end of the resilient bar 5, and the position where the cam 71 and the resilient bar 5 are pressed against each other defines a press point 8. If the blade 4 is received completely into the knife handle 3, the press point 8 will be situated between an end of the knife handle 3 and the pivotal connecting position, so that the resilient bar 5 can produce a torque to the cam 71 to drive the blade 4 to pivot towards the knife handle 3, and the blade 4 can be received stably and completely into the knife handle 3. If the push switch 6 pushes the blade 4 to pivot until the press point 8 is moved to a position between the pivotal connecting position and an other end of the knife handle 3, then the direction of the force applied by resilient bar 5 onto the cam 71 will be changed, and the resilient bar 5 will produce a torque to turn the blade 4 out from the knife handle 3, and finally the blade 4 will pivot out of the knife handle 3 automatically.

Referring to FIG. 3 for a second preferred embodiment of the present invention, the folding knife includes a protruding pillar 72 disposed on the blade 4 and installed at the pivotal connecting position of the blade 4 and the knife handle 3, and the position where the protruding pillar 72 is pressed by another end of the resilient bar 5 defines a press point 8. If the blade 4 is received completely into the knife handle 3, the press point 8 will be situated between an end of the knife handle 3 and the pivotal connecting position, so that the resilient bar 5 can produce a torque to the protruding pillar 72 to drive the blade 4 to pivot towards the knife handle 3. If the push switch 6 pushes the blade 4 to pivot until the press point 8 is moved to a position between the pivotal connecting position and another end of the knife handle 3, the direction of a force applied by the resilient bar 5 onto the protruding pillar 72 will be changed, and the resilient bar 5 will produce a torque to drive the blade 4 to pivot out of the knife handle 3, and finally the blade 4 will pivot out of the knife handle 3 automatically.

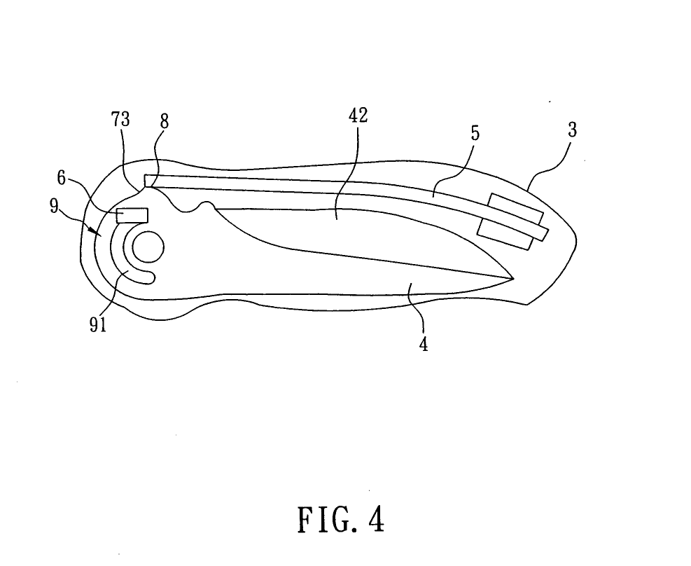

In the third preferred embodiment of the present invention as shown in FIG. 4, the blade 4 has a press edge 73 disposed at the periphery of an end of the blade 4, and the position where the press edge 73 is pressed by another end of the resilient bar 5 defines a press point 8. If the blade 4 is received completely into the knife handle 3, the press point 8 will be situated between an end of the knife handle 3 and the pivotal connecting position, and the resilient bar 5 will produce a torque to the press edge 73 to drive the blade 4 to pivot towards the knife handle 3. When the push switch 6 pushes the blade 4, until the press point 8 is moved to a position between the pivotal connecting position and another end of the knife handle 3, the direction of applying a force by the resilient bar 5 onto the press edge 73 will be changed, and the resilient bar 5 will produce a torque to turn the blade 4 out from the knife handle 3, and finally the blade 4 will pivot out of the knife handle 3 automatically.

In FIGS. 2 and 3, the blade 4 of the abovementioned first, second and third embodiments has a push edge 40 disposed at the periphery of an end of the blade 4, and the push edge 40 and another end of the push switch 6 are pushed and coupled with each other, and provided for the push switch 6 to push the blade 4, so that when the blade 4 is pushed to turn and gradually change the direction of applying a force from the resilient bar 5 to the cam 71, the protruding pillar 72 or the press edge 73 until the resilient bar 5 produces a torque to turn the blade 4 out from the knife handle 3.

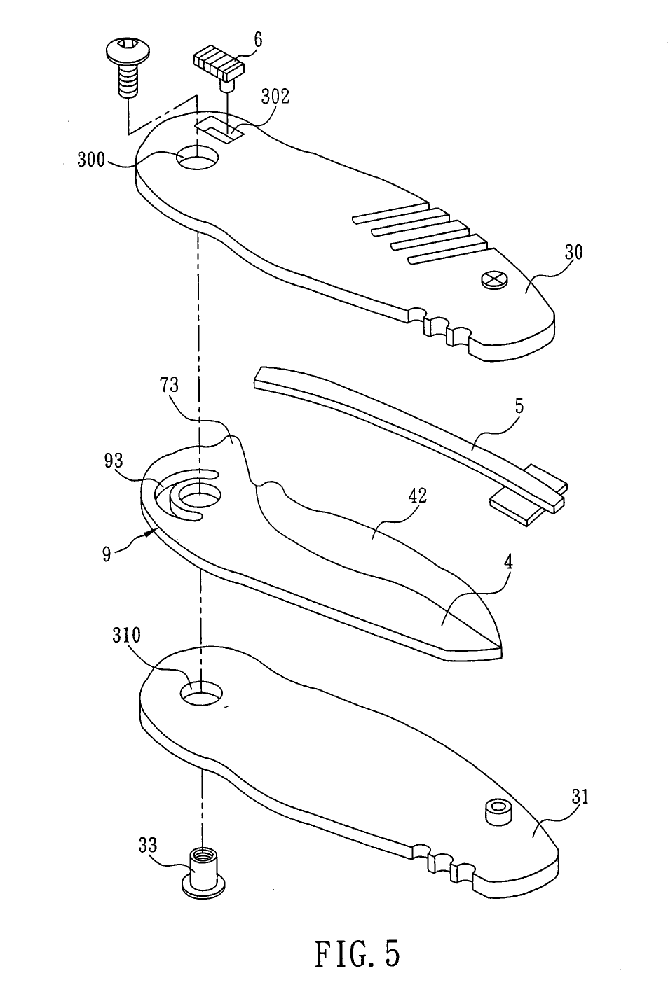

In FIG. 5, the knife handle 3 of the abovementioned first, second and third preferred embodiments is comprised of a first plate body 30 and a second plate body 31 engaged with each other and provided for receiving the blade 4, the resilient bar 5, the cam 71, the protruding pillar 72 or the press edge 73 into the knife handle 3, wherein the first plate body 30 faces a surface of the blade 4, and the first plate body 30 includes a first penetrating hole 300 and a push hole 302 disposed separately and proximate to an end of the first plate body. The first penetrating hole 300 is provided for passing a pivotal shaft 33, and the push hole 302 is disposed proximate to the first penetrating hole 300 for passing the push switch 6 through the knife handle 3, and provided for the push switch 6 to slide in the push hole 302 to control whether or not to turn the blade 4 out from the knife handle 3. The second plate body 31 faces another surface of the blade 4, and the second plate body 31 has a second penetrating hole 310 disposed proximate to an end of the second plate body 31 for passing the pivotal shaft 33. With the first penetrating hole 300, the second penetrating hole 310 and the pivotal shaft 33, an end of the blade 4 can be pivotally coupled into an end of the knife handle 3.

In FIGS. 4 and 5, the pivotal position of the blade 4 and the knife handle 3 in accordance with the third preferred embodiment has an indent portion 9 for extending another end of the push switch 6 therein, and the indent portion 9 is in a semicircular arc shape, and a side of a knife-edge portion is disposed at an end of the indent portion 9 and proximate to the blade 4, and another side of the knife-edge portion is wound through an end proximate to the blade 4 by using the pivotal connecting position as an axial center, and extended to another side of the blade 4, so that if another end of the push switch 6 keeps pushing an end of the indent portion 9, the blade 4 will be pushed by the push switch 6. After the blade 4 pivots out of the knife handle 3, another end of the push switch 6 slides from an end of the indent portion 9 to another end of the indent portion 9, and thus will not hinder the blade 4 from turning out from the knife handle 3.

In FIGS. 4 and 5, the indent portion 9 of the third preferred embodiment is set on a groove 91 of the blade 4 or built as a slot 93 of the blade 4. Regardless of the way of setting the indent portion 9 on the blade 4, the present invention can accommodate such design with a simple modification. In addition, another end of the push switch 6 of the foregoing three embodiments can be used for pushing the push edge 40 or the indent portion 9, as well as pushing an end of the blade 4, and the components such as the press edge 73, the cam 71 and the protruding pillar 72.

While the invention has been described by means of specific embodiments, numerous modifications and variations could be made thereto by those skilled in the art without departing from the scope and spirit of the invention set forth in the claims.

What is claimed is:

1. A folding knife, comprising:
a knife handle;
a blade, with an end pivotally coupled to an end of the knife handle, and the blade can be pivoted out of the knife handle or received completely into the knife handle with respect to a pivotal connecting position of the blade and the knife handle;
a resilient bar, with an end fixed into another end of the knife handle, and another end of the resilient bar extended to the blade proximate at the pivotal connecting position of the blade and the knife handle and, such that when the blade is received completely into the knife handle, the resilient bar will produce a torque to turn the blade towards the knife handle; and
a push switch, installed on the knife handle and proximate to the pivotal connecting position of the knife handle and the blade, and an end of the push switch is extended to a surface of the knife handle, and another end of the push switch is passed through the knife handle and is against the blade, so that when the push switch pushes the blade to turn to a predetermined angle, the resilient bar produces a torque to turn the blade out from the knife handle, such that the blade pivots out of the knife handle automatically.

2. The folding knife as recited in claim 1, wherein the blade includes a cam disposed at the pivotal connecting position of the blade and the knife handle, and the position at the periphery of the cam being pressed by another end of the resilient bar defines a press point, such that when the blade is received completely into the knife handle, the resilient bar will produce a torque to the cam to drive the blade to turn towards the knife handle, and when the push switch pushes the blade to turn to a predetermined angle, the resilient bar will produce a torque to turn the blade out from the knife handle, so that the blade can pivot out of the knife handle automatically.

3. The folding knife as recited in claim 1, wherein the blade includes a protruding pillar disposed proximate to the pivotal connecting position of the blade and the knife handle, and the position where the protruding pillar is pressed by another end of the resilient bar defines a press point, such that when the blade is received completely into the knife handle, the resilient bar will produce a torque to the protruding pillar to drive the blade to turn towards the knife handle, and when the push switch pushes the blade to turn to a predetermined angle, the resilient bar will produce a torque to turn the blade out from the knife handle, and the blade will pivot out of the knife handle automatically.

4. The folding knife as recited in claim 1, wherein the blade includes a press edge disposed at the periphery of an end of the blade, and the position where the press edge is pressed by another end of the resilient bar defines a press point, such that when the blade is received completely into the knife handle, the resilient bar will produce a torque to the press edge to drive the blade to turn out from the knife handle, and when the push switch pushes the blade to turn to a predetermined angle, the resilient bar will produce a torque to turn the blade out from the knife handle, so that the blade can pivot out of the knife handle automatically.

5. The folding knife as recited in claim 2, wherein the blade has a push edge disposed at the periphery of an end of the blade, and the push edge is pressed against another end of the push switch.

6. The folding knife as recited in claim 3, wherein the blade has a push edge disposed at the periphery of an end of the blade, and the push edge is pressed against another end of the push switch.

7. The folding knife as recited in claim 4, wherein the blade has a push edge disposed at the periphery of an end of the blade, and the push edge is pressed against another end of the push switch.

8. The folding knife as recited in claim 5, wherein the knife handle comprises:
a first plate body, facing a surface of the blade, and having a first penetrating hole and a push hole, both disposed proximate to an end of the first plate body, and the first penetrating hole is provided for passing a pivotal shaft, and the push hole is provided for passing the push switch; and
a second plate body, facing another surface of the blade, and having a second penetrating hole disposed proximate to an end of the second plate body for passing the pivotal shaft.

9. The folding knife as recited in claim 6, wherein the knife handle comprises:
a first plate body, facing a surface of the blade, and having a first penetrating hole and a push hole, both disposed proximate to an end of the first plate body, and the first penetrating hole is provided for passing a pivotal shaft, and the push hole is provided for passing the push switch; and
a second plate body, facing another surface of the blade, and having a second penetrating hole disposed proximate to an end of the second plate body for passing the pivotal shaft.

10. The folding knife as recited in claim 7, wherein the knife handle comprises:
a first plate body, facing a surface of the blade, and having a first penetrating hole and a push hole, both disposed proximate to an end of the first plate body, and the first penetrating hole is provided for passing a pivotal shaft, and the push hole is provided for passing the push switch; and
a second plate body, facing another surface of the blade, and having a second penetrating hole disposed proximate to an end of the second plate body for passing the pivotal shaft.

11. The folding knife as recited in claim 3, wherein the blade has an indent portion disposed proximate to the pivotal connecting position of the blade and the knife handle for receiving another end of the push switch, and an end of the indent portion proximate to the blade is a side of a knife-edge portion, and another end of the indent portion is wound around an end of the blade by using the pivotal connecting position as an axial center, and extended to another side of the blade.

12. The folding knife as recited in claim 4, wherein the blade has an indent portion disposed proximate to the pivotal connecting position of the blade and the knife handle for receiving another end of the push switch, and an end of the indent portion proximate to the blade is a side of a knife-edge portion, and another end of the indent portion is wound around an end of the blade by using the pivotal connecting position as an axial center, and extended to another side of the blade.

13. The folding knife as recited in claim 11, wherein the indent portion is a groove.

14. The folding knife as recited in claim 12, wherein the indent portion is a groove.

15. The folding knife as recited in claim 11, wherein the indent portion is a slot.

16. The folding knife as recited in claim 12, wherein the indent portion is a slot.

17. The folding knife as recited in claim 15, wherein the knife handle comprises:
a first plate body, facing a surface of the blade, and having a first penetrating hole and a push hole, both disposed proximate to the first plate body, and the first penetrating hole is provided for passing a pivotal shaft, and the push hole is provided for passing the push switch; and
a second plate body, facing another surface of the blade, and having a second penetrating hole disposed proximate to an end of the second plate body for passing the pivotal shaft.

18. The folding knife as recited in claim 16, wherein the knife handle comprises:
a first plate body, facing a surface of the blade, and having a first penetrating hole and a push hole, both disposed proximate to the first plate body, and the first penetrating hole is provided for passing a pivotal shaft, and the push hole is provided for passing the push switch; and
a second plate body, facing another surface of the blade, and having a second penetrating hole disposed proximate to an end of the second plate body for passing the pivotal shaft.
